(19) United States
(12) Patent Application Publication
(10) Pub. No.: US 2003/0033538 A1
(43) Pub. Date: Feb. 13, 2003

(54) Bank note evaluation apparatus and bank note evaluation result data processing method

(76) Inventor: Masahiro Shishikura, Tokyo (JP)

Correspondence Address: PILLSBURY WINTHROP, LLP, P.O. BOX 10500, MCLEAN, VA, 22102, US

(21) Appl. No.: 10/217,303

(22) Filed: Aug. 13, 2002

(30) Foreign Application Priority Data
Aug. 13, 2001 (JP) 2001-245569

(51) Int. Cl. G06F 12/14

(52) U.S. Cl. 713/193

(57) ABSTRACT

In a bank note evaluation data processing method according to an aspect of this invention, bank note evaluation result data and unique data are encrypted by an encryption key to generate encrypted data. The bank note evaluation result data, unique data, and encrypted data are transmitted.

### CROSS-REFERENCE TO RELATED APPLICATIONS

This application is based upon and claims the benefit of priority from the prior Japanese Patent Application No. 2001-245569, filed Aug. 13, 2001, the entire contents of which are incorporated herein by reference.

### BACKGROUND OF THE INVENTION

1. Field of the Invention

The present invention relates to a bank note evaluation apparatus which evaluates a bank note, cuts a soiled bank note, and outputs evaluation result data containing data representing the number of cut notes. The present invention also relates to a bank note evaluation data processing method of evaluation a bank note, cutting a soiled bank note, and processing evaluation result data containing data representing the number of cut notes.

2. Description of the Related Art

Bank note evaluation result data obtained along with evaluation of bank notes is very important. For example, a soiled bank note is cut in evaluation of bank notes. The evaluation result data contains the number of cut notes. To change evaluation result data, it is necessary to input the user name and password of the manager, thereby logging them on the OS (the Windows). Evaluation result data is so managed as not to be easily changed. This prevents tampering of evaluation result data.

However, this evaluation result data tampering prevention measure is insufficient. For example, if the user name and password of the manager leak, evaluation result data is easily tampered. In transmitting evaluation result data to a customer server via a network, data on the network may be tampered.

The present invention has been made in consideration of the above situation, and has as its object to provide a bank note evaluation apparatus and bank note evaluation result data processing method capable of improving the security of bank note evaluation result data.

### BRIEF SUMMARY OF THE INVENTION

To overcome the conventional drawbacks and achieve the above object, a bank note evaluation apparatus and bank note evaluation result data processing method according to the present invention have the following arrangement.

(1) A bank note evaluation apparatus according to an aspect of the present invention comprises an encrypted data generation unit configured to encrypt bank note evaluation result data and unique data by an encryption key and generate encrypted data, and an output unit configured to output the bank note evaluation result data, the unique data, and the encrypted data.

(2) A bank note evaluation data processing method according to another aspect of the present invention comprises encrypting bank note evaluation result data and unique data by an encryption key to generate encrypted data, and outputting the bank note evaluation result data, the unique data, and the encrypted data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the schematic arrangement of a bank note evaluation system according to an embodiment of the present invention; and

FIG. 2 is a flowchart showing a bank note evaluation result data processing method according to the embodiment of the present invention.

### DETAILED DESCRIPTION OF THE INVENTION

A preferred embodiment of the present invention will be described below with reference to the several views of the accompanying drawing.

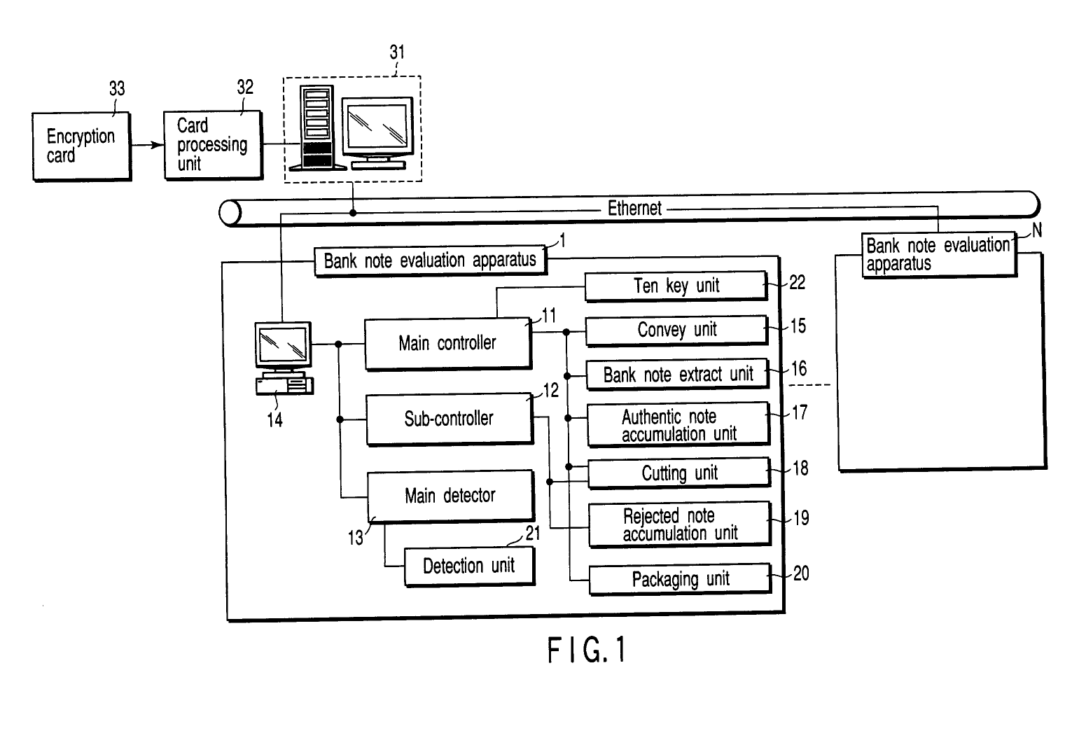

FIG. 1 is a block diagram showing the schematic arrangement of a bank note evaluation system according to the embodiment of the present invention.

As shown in FIG. 1, the bank note evaluation system comprises a plurality of (N) bank note evaluation apparatuses 1 to N. Each bank note evaluation apparatus comprises a main controller 11, sub-controller 12, main detector 13, PC 14, convey unit 15, bank note extract unit 16, authentic note accumulation unit 17, cutting unit 18, rejected note accumulation unit 19, packaging unit 20, detection unit 21, and ten key unit 22.

The main controller 11, sub-controller 12, and main detector 13 are USB-connected to the PC 14. The main controller 11 is connected to the convey unit 15, bank note extract unit 16, authentic note accumulation unit 17, cutting unit 18, rejected note accumulation unit 19, and ten key unit 22. The sub-controller 12 is connected to the cutting unit 18 and packaging unit 20. The main detector 13 is connected to the detection unit 21.

The PC 14 and a customer server 31 are connected by a LAN such as Ethernet.

The main controller 11 saves an encryption key, and this encryption key cannot be externally read out. That is, the PC 14 cannot read out the encryption key from the main controller 11.

The customer server 31 is connected to a card processing unit 32. The card processing unit 32 accepts, e.g., an IC card and processes the accepted IC card. The card processing unit 32 transfers data from the customer server 31 to the IC card, or transfers data from the IC card to the customer server 31.

Data encryption by the card processing unit 32 and an encryption card (IC card) 33 which stores an externally unreadable encryption key will be explained. First, the card processing unit 32 accepts the encryption card 33. Then, the customer server 31 transfers data to be encrypted to the card processing unit 32. In correspondence with this, the card processing unit 32 transfers the data to be encrypted to the encryption card 33. The encryption card 33 uses its stored encryption key to encrypt the data, and outputs the encrypted data to the card processing unit 32. The card processing unit 32 outputs the encrypted data to the customer server 31. As a result, data encryption by the encryption key stored in the encryption card 33 can be realized.

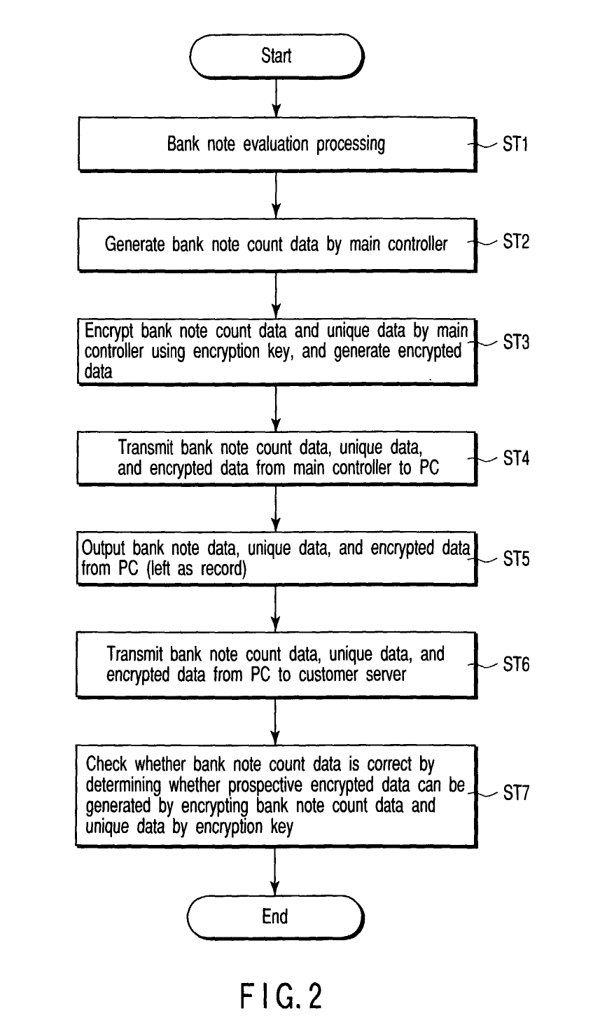

Processing of bank note evaluation result data will be explained with reference to the flowchart shown in FIG. 2.

The bank note evaluation apparatus 1 evaluates a bank note (ST1). Evaluation of a bank note will be briefly described. A plurality of bank notes to be evaluated are accumulated in the bank note extract unit 16. The bank notes accumulated in the bank note extract unit 16 are extracted one by one, and conveyed to the detection unit 14 by the convey unit 15. The detection unit 14 executes various detection processes for the conveyed bank note. From the detection result by the detection unit 14, the main detector 13 determines whether the bank note is an authentic note, damaged note, or rejected note. A bank note determined as an authentic note is conveyed to the authentic note accumulation unit 17 where the bank note is accumulated. A bank note determined to be a damaged note is conveyed to the cutting unit 18 where the bank note is cut. A bank note determined as a rejected note is transferred to the rejected note accumulation unit 19 where the bank note is accumulated. The authentic note accumulation unit 17 counts the number of accumulated bank notes (authentic notes), and notifies the main controller 11 of the count. Similarly, the cutting unit 18 counts the number of cut bank notes (damaged notes), and notifies the main controller 11 of the count.

The convey unit 15 counts rejection and supplies the data representing the count, to the main controller 11. The rejected note accumulation unit 19 may receive two rejected notes at the same time. In this case, too, the convey unit 15 counts these rejected notes as one rejection.

Bank notes are passed through the convey unit 15, in units of 100 pieces. Of every 100 bank notes, two or more are usually rejected. Assume that six of 100 bank notes are rejected and that two of the six rejected notes simultaneously are picked up. If this is the case, the count is “5”, not ““6”. The operator counts the rejected note correctly and inputs the count “6”, operating the ten key unit 22.

The main controller 11 sums up the count data from the authentic note accumulation unit 17, cutting unit 18, and rejected note accumulation unit 19, and generates bank note count data as an evaluation result (ST2).

The main controller 11 encrypts the bank note count data and unique data by an encryption key saved in advance, thereby generating encrypted data (ST3). The encrypted data is called a MAC (Message Authentication Code). Encryption uses, e.g., triple DES (Data Encryption Standard). The unique data is, e.g., the total of bank note count data, the evaluation date and time, or the counter values of various counters of the bank note evaluation apparatus. The bank note count data represents the number of cut note.

The main controller 11 transmits the bank note count data, unique data, and encrypted data to the PC 14 (ST4). The encryption key cannot be read out from the main controller 11. Hence, the PC 14 cannot be used to tamper with the bank note count data or generate encrypted data in accordance with tampering. At the end of operation, the PC 14 outputs the bank note count data, unique data, and encrypted data to the evaluation log (ST5). That is, the PC 14 keeps the bank note count data, unique data, and encrypted data as records. To sum up bank note count data at the customer server 31, the PC 14 transmits the bank note count data, unique data, and encrypted data to the customer server 31 (ST6). The customer server 31 receives the bank note count data, unique data, and encrypted data.

Whether the bank note count data is correct can be checked by confirming whether the result of encrypting the bank note count data and unique data output to the evaluation log coincides with the encrypted data output to the evaluation log (ST7). The customer server 31 can check whether the bank note count data is corrected, by confirming whether the result of encrypting the bank note count data and unique data transmitted from the PC 14 coincides with the transmitted encrypted data (ST7).

The present invention will be summarized below.

As described above, the PC 14 cannot correct encrypted data, and therefore cannot be used to tamper with bank note count data.

By using a built-in OS (Operating System) other than Windows for the main controller 11, a person who does not have any knowledge about the built-in OS cannot easily enter the main controller 11. An example of the built-in OS is an OS unique to a device. The “OS unique to a device” means an OS customized for each device even if the OS is different between devices. The use of an OS unique to a device makes it very difficult to enter the device. As a result, it becomes very difficult to steal an encryption key from the main controller 11. Data tampering can be prevented by saving an encryption key in the main controller 11 and encrypting bank note count data by the main controller 11.

Even the same bank note count data (the same cut note count data) provides different encryption results by using the total of count information within operation, the evaluation date and time, and the count values of various counters in encryption. This can prevent tampering with the bank note count data.

Assume that 200 bank notes were cut yesterday and that 100 bank notes are cut today. In this case, the cut note count data for yesterday cannot be used for today. This is because the cut note count data items are encrypted by using different data and time data items.

The data transferred through the USB has been encrypted. Hence, even if the data is stolen, it cannot be easily tempered with.

Bank note count data contains data representing the number of cut damaged notes. Damaged notes have already been cut and do not exist. If bank note count data is tampered with, the number of cut damaged notes can be falsely reported. A damaged note is also a bank note, and fraud can be carried out by misreporting the number of cut damaged notes as if more damaged notes were cut than the actual number of cut damaged notes. Needless to say, authentic notes can be taken out, by misreporting the number of cut authentic notes as if authentic notes were cut in a greater number than actually cut. Such tampering with bank note count data can be prevented by adopting the above-described bank note count data encryption processing, and theft of bank notes can also be prevented. Prevention of tampering with bank note count data is very important for a bank note evaluation apparatus having a function of cutting damaged notes.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A bank note evaluation apparatus which evaluates a bank note and outputs an evaluation result, comprising:
an encrypted data generation unit configured to encrypt bank note evaluation result data and unique data by an encryption key and generate encrypted data; and
an output unit configured to output the bank note evaluation result data, the unique data, and the encrypted data.

2. An apparatus according to claim 1, which comprises a cutting unit configured to cut a bank note, and
in which the bank note evaluation result data contains data representing the number of bank notes cut by said cutting unit.

3. An apparatus according to claim 1, wherein the unique data includes data generated from date data and time data.

4. An apparatus according to claim 1, wherein said encrypted data generation unit generates the encrypted data under the control of an operating system unique to said apparatus.

5. A bank note evaluation data processing method of processing a bank note evaluation result, comprising:
encrypting bank note evaluation result data and unique data by an encryption key to generate encrypted data; and
outputting the bank note evaluation result data, the unique data, and the encrypted data.

6. A method according to claim 5, wherein the bank note evaluation result data includes data representing the number of cut bank notes.

7. A method according to claim 5, wherein the unique data includes data generated from date data and time data.

8. A method according to claim 5, wherein the bank note evaluation data processing method generates the encrypted data under the control of an operating system unique to an apparatus.

9. A bank note evaluation data processing method of processing a bank note evaluation result, comprising:
encrypting bank note evaluation result data and unique data by an encryption key to generate encrypted data;
outputting the bank note evaluation result data, the unique data, and the encrypted data;
receiving the output bank note evaluation result data, the output unique data, and the output encrypted data;
encrypting the received bank note evaluation result data and the received unique data by the encryption key to newly generate encrypted data; and
comparing the newly generated encrypted data with the received encrypted data to confirm that the output bank note evaluation result data is correctly received without tampering.

10. A method according to claim 9, wherein the bank note evaluation result data includes data representing the number of cut bank notes.

11. A method according to claim 9, wherein the unique data includes data generated from date data and time data.

12. A method according to claim 9, wherein the bank note evaluation data processing method generates the encrypted data under the control of an operating system unique to an apparatus.
